(19) United States
(12) Patent Application Publication
(10) Pub. No.: US 2026/0172158 A1
(43) Pub. Date: Jun. 18, 2026

(54) SCHEDULING INDICATION OF A PDU SET PRIORITIZATION IN UPLINK

(71) Applicant: Telefonaktiebolaget LM Ericsson (publ), Stockholm (SE)

(72) Inventors: Richard TANO, STOCKHOLM (SE); Jose Luis PRADAS, STOCKHOLM (SE); Du Ho KANG, SOLLENTUNA (SE)

(73) Assignee: Telefonaktiebolaget LM Ericsson (publ), Stockholm (SE)

(21) Appl. No.: 19/128,612

(22) PCT Filed: Nov. 10, 2023
(86) PCT No.: PCT/SE2023/051137

§ 371 Date: May 9, 2025

Related U.S. Application Data
(60) Provisional application No. 63/424,685, filed on Nov. 11, 2022.

(51) Int. Cl. H04L 5/00; H04W 72/23

(52) U.S. Cl. CPC H04L 5/001; H04L 5/0053; H04L 5/0055; H04W 72/23

(57) ABSTRACT

A method by a UE includes receiving an indication that indicates which protocol data unit, PDU, set, among a plurality of PDU sets in a transmit buffer of the UE, is to be transmitted by the UE in response to an uplink grant corresponding to the indication, receiving the uplink grant corresponding to the indication, and transmitting an uplink transmission according to the uplink grant in accordance with the indication. A method by a network node includes transmitting an indication to a UE that indicates which PDU set is to be transmitted by the UE in response to an uplink grant corresponding to the indication, transmitting the uplink grant corresponding to the indication to the UE, and receiving an uplink transmission from the UE according to the uplink grant in accordance with the indication.

### TECHNICAL FIELD

The present disclosure relates to wireless communication networks, and in particular to scheduling of resources in wireless communication networks.

### BACKGROUND

5G is the fifth generation of mobile communications, addressing a wide range of use cases from enhanced mobile broadband (eMBB) to ultra-reliable low-latency communications (URLLC) to massive machine type communications (mMTC). 5G includes the New Radio (NR) access stratum interface and the 5G Core Network (5GC). The NR physical and higher layers are reusing parts of the LTE specification, and to that add needed components when motivated by new use cases.

Low-latency high-rate applications such as extended Reality (XR) and cloud gaming are important in 5G era. XR may refer to all real-and-virtual combined environments and human-machine interactions generated by computer technology and wearables. It is an umbrella term for different types of realities including Virtual Reality (VR), Augmented Reality (AR), Mixed Reality (MR), and similar technologies. The levels of virtuality range from partially sensory inputs to fully immersive VR.

5G NR is designed to support applications demanding high rate and low latency in line with the requirements posed by the support of XR and cloud gaming applications in NR networks. 3GPP Release 17 contains a study item on XR Evaluations for NR. The main objectives are to identify the traffic model for each application of interest, the evaluation methodology and the key performance indicators of interest for relevant deployment scenarios, and to carry out performance evaluations accordingly in order to investigate possible standardization enhancements in potential follow-up standardization activities.

Applications such as XR and cloud gaming may require bounded latency, but not necessarily ultra-low latency. The end-to-end latency budget may be in the range of 20-80 ms, which needs to be distributed over several components including application processing latency, transport latency, radio link latency, etc. For these applications, short transmission time intervals (TTIs) or mini-slots targeting ultra-low latency may not be effective.

FIG. 1 shows an example of frame latency measured over a radio access network (RAN), excluding application & core network latencies. It can be seen that there exist frame latency spikes 12 in the RAN. In particular, the latency spikes 12 shown in FIG. 1 may occur due to instantaneous shortage of radio resources or inefficient radio resource allocation in response to varying frame size. For example, the sources for the latency spikes may include queuing delay, time-varying radio environments, time-varying frame sizes, among others. Tools that can help to remove latency spikes are beneficial to enable better 5G support for this type of traffic.

In addition to bounded latency requirements, applications such as XR and cloud gaming may also require high-rate transmission. This can be seen from the large frame sizes originated from this type of traffic. The typical frame sizes may range from tens of kilobytes to hundreds of kilobytes. The frame arrival rates may be 60 or 120 frames per second (fps). As a concrete example, a frame size of 100 kilobytes and a frame arrival rate of 120 fps can lead to a data rate requirement of 95.8 Mbps.

A large video frame is usually fragmented into smaller internet protocol (IP) packets and transmitted as several transport blocks (TBs) over several transmission time intervals (TTIs) in RAN. FIG. 2 shows an example of the cumulative distribution functions of the number of transport blocks required to deliver a video frame with size ranging from 20 KB (curve 22) to 300 KB (curve 24). For example, FIG. 2 shows that for delivering the frames with a size of 200 KB each, the median number of needed TBs is 5.

The characteristics of XR traffic arrival are quite distinct from typical web-browsing and voice over internet protocol (VoIP) traffic, as shown in FIG. 3. It is well expected that the arrival time is quasi-periodic and largely predictable as VoIP. However, its data size is order of magnitude larger than VoIP, as discussed above. In addition, similar to web-browsing, the data size is different at every application protocol data unit (PDU) arrival instance due to dynamics of contents and human motion.

### Basics of NR Scheduling

In 3GPP NR standard, downlink control information (DCI) is transmitted by the network to a user equipment (UE) over the physical downlink control channel (PDCCH). The PDCCH may carry DCI in messages with different formats. For example, DCI formats 0_0, 0_1, and 0_2 are DCI messages used to convey uplink grants to the UE for transmission of the physical layer data channel in the uplink (PUSCH). DCI formats 1_0, 1_1, and 1_2 are used to convey downlink assignments for transmission of the physical layer data channel on the downlink (PDSCH).

In NR, a frame has a duration of 10 ms and consists of 10 subframes. Each subframe consists of 2^{μ} slots of 14 orthogonal frequency division multiplexing (OFDM) symbols each, where p=0,1,2,3 for the subcarrier spacing of 15×2^{μ} kHz, respectively. Although a slot is a typical unit for transmission upon which scheduling operates, NR enables transmission to start at any OFDM symbol and last only as many symbols as needed for the communication.

A DCI usually only schedules a TB to be transmitted over a slot or a mini-slot on a scheduled cell by either same-carrier scheduling, where the scheduling DCI and the scheduled TB on a PDSCH/PUSCH are carried on a same serving cell, or cross-carrier scheduling, where the scheduling DCI and the scheduled TB on a PDSCH/PUSCH are carried on different serving cells. The TB may be transmitted over multiple slots or multiple mini-slots on the scheduled cell when slot aggregation is used. In Rel-16 NR Unlicensed work, the support of using one DCI grant scheduling multiple PUSCH transmissions, where each PUSCH carries a separate TB, is introduced. In Rel-17 work on dynamic spectrum sharing, there is an objective about studying, and if agreed, specifying PDCCH scheduling PDSCHs on multiple cells using a single DCI.

Besides dynamic scheduling, downlink (DL) transmission can be configured at higher layers using the semi persistent scheduling (SPS) framework, in which multiple periodic resources are granted at the same time, i.e. prior to a data transmission. Configuration of SPS includes periodicity of the grant, resource allocation in time and frequency and modulation and coding scheme (MCS) in SPS occasions, among others.

Similarly, allocating periodic UL transmission resources is also supported. This is known as “configured grant”, “UL transmission without grant”, or “grant-free transmission”. Two types of UL transmission with configured grant have been specified. In type 1 UL transmission with configured grant, resource allocation is only based on radio resource control (RRC) (re)configuration while DCI in L1 signalling is only used to activate/deactivate the configuration (similar to DL SPS). In type 2 UL transmission with configured grant, resource allocation is partly determined by RRC (re)configuration and partly determined by L1 signalling used for activating/deactivating the configuration.

### Resource Allocation Unit for XR Video Rendering

An application data unit (ADU) for video traffic in XR may include multiple IP packets which correspond to multiple PDUs at a gNB. The PDUs corresponding to a single ADU should be handled together for image rendering at an XR client application. It may be insufficient to deliver only one or few PDU packets from an ADU in order to update the video image. Therefore, 3GPP introduced a new concept to handle this issue called a ‘PDU set’. A PDU set is composed of one or more PDUs carrying the payload of one unit of information generated at the application level. In some implementations, all PDUs in a PDU set are needed by the application layer to use the corresponding unit of information. In other implementations, the application layer can still recover parts all or of the information unit, when some PDUs are missing.

A report mechanism from a UE may be used in order to differentiate, at a gNB, one PDU set from another PDU set in the same UE buffer. With this information, a scheduler may precisely select the number of bits corresponding to one PDU set for resource allocation. A UE may also report latency related information so that the gNB can apply prioritization for a resource grant based on both the PDU set and latency information.

There currently exist certain challenge(s). In general, for UL transmission, the packet which arrives first in a queue at the UE is transmitted before other packets which arrived later in that queue. For XR traffic, if a first PDU set has exceeded its PDU set delay budget (i.e. maximum time to deliver the PDU set), it may more effective to transmit a second PDU set which arrived later in the queue than this first PDU set.

When there is more than one PDU set in the UE buffer, it may be the case that the first PDU set that arrived in the buffer first cannot be delivered within the PDU set delay budget (PDB) because its remaining latency (known as PDB_left) is not large enough to transmit the PDU set. Nevertheless, the first PDU set will be allocated to a resource grant from a gNB since in the current UE specification, a UE will prioritize bits in its buffer based on the first come and first served manner. This may lead to the waste of resources for the first PDU set and unnecessary interference.

### SUMMARY

Some embodiments described herein may avoid the waste of uplink resource for PDU set allocation that cannot be delivered within a latency requirement. Moreover, some embodiments may reduce or minimize unnecessary interference for wasted resource of infeasible PDU set allocation in scheduling. Some embodiments described herein may further increase uplink capacity and latency of XR service by allocating resources only to feasible PDU sets.

A method performed by a UE according to some embodiments includes receiving an indication from a network node that indicates which protocol data unit, PDU, set, among a plurality of PDU sets in a transmit buffer of the UE, is to be transmitted by the UE in response to an uplink grant corresponding to the indication, receiving the uplink grant corresponding to the indication, and transmitting an uplink transmission according to the uplink grant in accordance with the indication.

The indication may indicate a PDU set in the transmit buffer of the UE that can be transmitted according to the uplink grant.

The indication may indicate a plurality of PDU sets in the transmit buffer of the UE that can be transmitted according to the uplink grant.

The indication may include an index of the PDU set, such as a sequence number of the PDU set, a priority index, etc.

The indication may indicate that the UE should transmit PDU sets having an index determined relative to the indicated index. For example, the indication may indicate that the UE should transmit PDU sets having an index at least as high as the indicated index.

The indication may indicate a PDU set in the transmit buffer that should not be transmitted according to the uplink grant.

The indication may be sent in a downlink control information, DCI, message containing the uplink grant.

The method may further include transmitting a PDU set, other than the indicated PDU set, after transmitting the indicated PDU set.

The indication may be sent in a control message.

The control message may include a medium access control (MAC) control element (CE).

The method may further include providing user data, and forwarding the user data to a host via the transmission to the network node.

A UE according to some embodiments includes processing circuitry and power supply circuitry configured to supply power to the processing circuitry, wherein the processing circuitry is configured to perform operations including receiving an indication from a network node that indicates which protocol data unit, PDU, set, among a plurality of PDU sets in a transmit buffer of the UE, is to be transmitted by the UE in response to an uplink grant corresponding to the indication, receiving the uplink grant corresponding to the indication, and transmitting an uplink transmission according to the uplink grant in accordance with the indication.

A UE includes an antenna configured to send and receive wireless signals, radio front-end circuitry connected to the antenna and to processing circuitry, and configured to condition signals communicated between the antenna and the processing circuitry, an input interface connected to the processing circuitry and configured to allow input of information into the UE to be processed by the processing circuitry, and an output interface connected to the processing circuitry and configured to output information from the UE that has been processed by the processing circuitry.

The processing circuitry is configured to perform operations including receiving an indication from a network node that indicates which protocol data unit, PDU, set, among a plurality of PDU sets in a transmit buffer of the UE, is to be transmitted by the UE in response to an uplink grant corresponding to the indication, receiving the uplink grant corresponding to the indication, and transmitting an uplink transmission according to the uplink grant in accordance with the indication.

A method performed by a network node according to some embodiments includes transmitting an indication to a user equipment, UE, that indicates which protocol data unit, PDU set, among a plurality of PDU sets in a transmit buffer of the UE, is to be transmitted by the UE in response to an uplink grant corresponding to the indication, transmitting the uplink grant corresponding to the indication to the UE, and receiving an uplink transmission from the UE according to the uplink grant in accordance with the indication.

The indication may indicate a PDU set in the transmit buffer of the UE that can be transmitted according to the uplink grant.

The indication may indicate a plurality of PDU sets in the transmit buffer of the UE that can be transmitted according to the uplink grant.

The indication may include an index of the PDU set.

The indication may indicate that the UE should transmit PDU sets having an index determined relative to the indicated index. For example, the indication may indicate that the UE should transmit PDU sets having an index at least as high as the indicated index.

The indication may indicate a PDU set in the transmit buffer that should not be transmitted according to the uplink grant.

The indication may be sent in a downlink control information, DCI, message containing the uplink grant.

The method may further include receiving a PDU set, other than the indicated PDU set, from the UE after receiving the indicated PDU set.

The indication may be sent in a control message.

The control message may include a MAC CE.

The method may further include obtaining user data, and forwarding the user data to a host or a user equipment.

A network node according to some embodiments includes processing circuitry and power supply circuitry configured to supply power to the processing circuitry. The processing circuitry is configured to perform operations including transmitting an indication to a user equipment, UE, that indicates which protocol data unit, PDU set, among a plurality of PDU sets in a transmit buffer of the UE, is to be transmitted by the UE in response to an uplink grant corresponding to the indication, transmitting the uplink grant corresponding to the indication to the UE, and receiving an uplink transmission from the UE according to the uplink grant in accordance with the indication.

A network node according to some embodiments includes an antenna configured to send and receive wireless signals, radio front-end circuitry connected to the antenna and to processing circuitry, and configured to condition signals communicated between the antenna and the processing circuitry, an input interface connected to the processing circuitry and configured to allow input of information into the network node to be processed by the processing circuitry, and an output interface connected to the processing circuitry and configured to output information from the network node that has been processed by the processing circuitry.

The processing circuitry is configured to perform operations including transmitting an indication to a user equipment, UE, that indicates which protocol data unit, PDU set, among a plurality of PDU sets in a transmit buffer of the UE, is to be transmitted by the UE in response to an uplink grant corresponding to the indication, transmitting the uplink grant corresponding to the indication to the UE, and receiving an uplink transmission from the UE according to the uplink grant in accordance with the indication.

### BRIEF DESCRIPTION OF DRAWINGS

FIG. 1 shows an example of frame latency measured over a radio access network (RAN).

FIG. 2 shows an example of the cumulative distribution functions of the number of transport blocks required to deliver a video frame with size ranging from 20 KB to 300 KB.

FIG. 3 illustrates characteristics of XR traffic arrival compared to typical web-browsing and VoIP traffic.

FIG. 4 illustrates an example of UE 1 which has three PDU sets A, B, C in its transmit buffer.

FIGS. 5 to 10 illustrate example operations according to embodiments of the inventive concepts.

FIG. 11 illustrates operations of a user equipment according to some embodiments.

FIG. 12 illustrates operations of a network node according to some embodiments.

FIG. 13 shows an example of a communication system in accordance with some embodiments.

FIG. 14 shows a UE in accordance with some embodiments.

FIG. 15 shows a network node in accordance with some embodiments.

FIG. 16 is a block diagram of a host in accordance with various aspects described herein.

FIG. 17 is a block diagram illustrating a virtualization environment in which functions implemented by some embodiments may be virtualized.

FIG. 18 shows a communication diagram of a host communicating via a network node with a UE over a partially wireless connection in accordance with some embodiments.

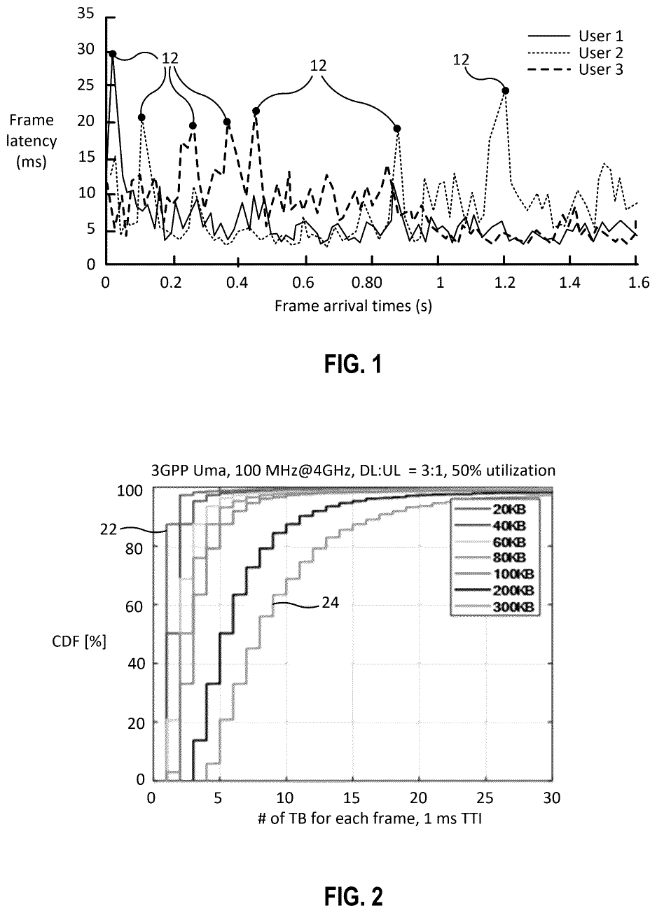

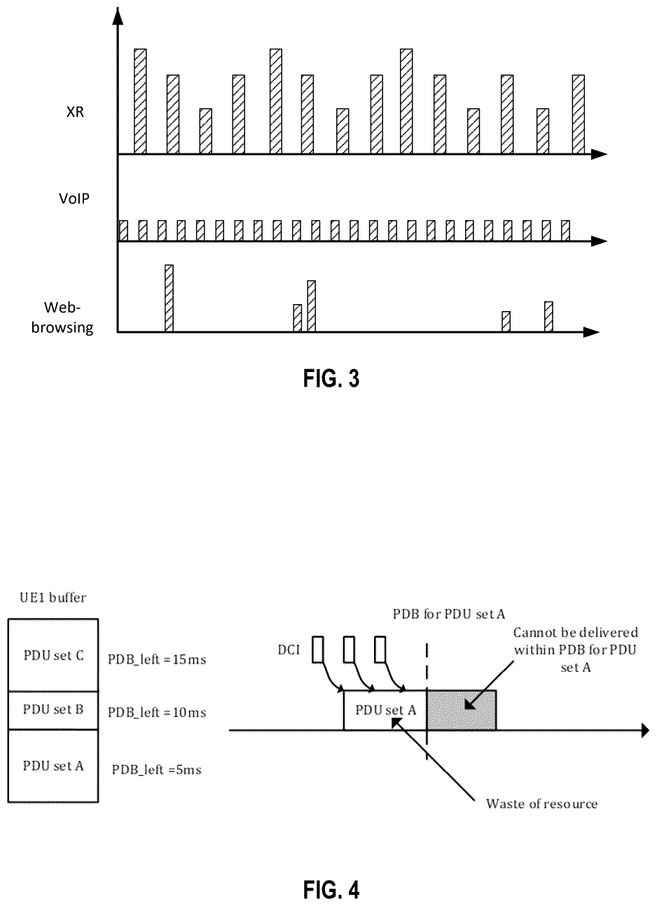

### DETAILED DESCRIPTION

FIG. 4 illustrates an example of UE 1 which has three PDU sets A, B, C in its transmit buffer. Each PDU set has a different PDB_left value, since their arrival times were different. In this example, PDU set A arrived first, PDU set B arrived second and PDU set C arrived third. PDU set A has a PDB_left value of 5 ms, PDU set B has a PDB_left value of 10 ms, and PDU set C has a PDB_left value of 15 ms.

A gNB sends three grants to the UE via DCI and a UE first allocates bits for PDU set A. However, the PDB for PDU set A expires before the UE can transmit all of the bits in the buffer for PDU set A. The remaining bits of PDU set A cannot be delivered, since they cannot be sent before expiration of the PDB for PDU set A.

From an XR experience, partial delivery of one PDU set is not enough. Thus, the partial delivery of PDU set A represents a waste of resources. Therefore, it would be beneficial to have a solution to avoid such resource allocation in advance so that a UE will transmit only those PDU sets that will meet the QoS requirements, such as the PDB.

Certain aspects of the disclosure and their embodiments may provide solutions to these or other challenges. According to some embodiments, a network node/gNB may provide to the UE an indication of which PDU set is to be transmitted using an assigned UL grant in order to avoid infeasible PDU set delivery, considering the size and latency information of all PDU sets in a UE buffer. The indication can be dynamic by physical layer signaling, such as DCI information in PDCCH, or be a semi-static indication provided, for example in a medium access control (MAC) control element (MAC-CE).

Some of the embodiments contemplated herein will now be described more fully with reference to the accompanying drawings. Embodiments are provided by way of example to convey the scope of the subject matter to those skilled in the art.

In an example scenario, a UE has more than one PDU set in its buffer or across buffers. The PDU sets in the buffer may have different sizes, different arrival times and/or different remaining latency budgets (PDB_left) regardless of their arrival time to a UE buffer. Thus, for example, the first PDU set may not necessarily be the smallest PDU set in the buffer. Moreover, the PDB_left of the first PDU set can be shorter than that of the last PDB_set, or vice versa.

A gNB can know the information/status of each PDU set, e.g. size and PDB_left, based on a UE report, such as a buffer status report including such information. At the same time, the gNB may be capable of predicting how much UL resource is needed for each PDU set, and can determine if it is feasible to deliver it before the expiration of the PDB_left budget.

### Indication of Feasible PDU Sets

According to some embodiments, a gNB may provide an indication to a UE of which PDU set should be transmitted in a corresponding UL grant. The indication may be provided in different ways. For example, in some embodiments, the indication may be provided as an index for a PDU set(s) to be allocated for one or more grants. The index can be defined either based on a UE report or a configuration provided by the gNB.

In some embodiments, the indication may be provided as an index for a PDU set(s) not to be allocated for one or more grant.

In some embodiments, the indication may be provided as an index for a PDU set size threshold less or equal to which resource in one or more grants should be allocated.

In some embodiments, the indication may be provided as an index for a PDU set size threshold, larger than which, resource in one or more grants should not be allocated

In some embodiments, the indication may be provided as an index for a PDB_left threshold less than or equal to which resource in one or more grants should not be allocated.

In some embodiments, the indication may be provided as an index for a PDU_left threshold, larger than which resource in one or more grants should be allocated.

In some embodiments, the mapping between the index and the corresponding PDU set can be defined separately. Also high layer signaling for the mapping configuration can be sent. Such indication can be included in existing DCI fields, or new DCI fields can be added to be carried by PDCCH.

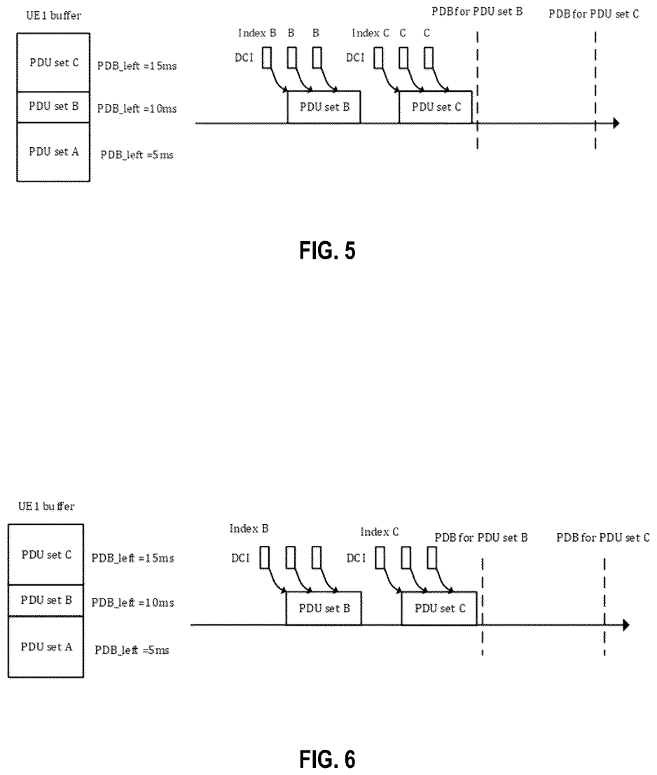

Example embodiments will now be described with reference to FIGS. 5 to 10. In each of the examples illustrated in FIGS. 5 to 10, a UE 1 has three PDU set A, B, C in its transmit buffer. Each PDU set has a different PDB_left value. In particular, PDU set A, which was received first in the UE's transmit buffer, has a PDB_left value of 5 ms. PDU set B has a PDB_left value of 10 ms, and PDU set C has a PDB_left value of 15 ms. In each example, the gNB may determine that there is not enough time left in the PDB of PDU set A for the entire PDU set to be transmitted by the UE.

Referring to FIG. 5, in some embodiments, a DCI with a corresponding PDU set index can be sent each time that a gNB sends a grant for UL data transmission. For example, the gNB may send DCI messages scheduling UL transmission by the UE on the PUSCH with an indication of index B for PDU set B. In response, the UE transmits PDU set B even though PDU set A was received in the buffer first. The gNB then sends send DCI messages with an indication of index C for PDU set C. In response, the UE transmits PDU set C on the PUSCH. The transmissions of both PDU set B and PDU set C are completed before the expiration of their respective PDBs.

In some embodiments, the DCI includes the corresponding PDU set index when a UE needs to change a PDU set for UL transmission. This DCI does not necessarily mean the DCI for data transmission but can be special DCI format.

For example, referring to FIG. 6, the gNB may send an indication of index B in, or in connection with, a first DCI uplink scheduling grant (also referred to herein as an uplink scheduling grant, a scheduling grant or an uplink grant), indicating that the UE should use the uplink scheduling grant to transmit PDU set B. The indication may not be sent again until the gNB indicates to the UE to change the PDU set for UL transmission. Thus, in the next DCI after the UE has finished transmitting PDU set B, the gNB includes an indication of index C that the UE should use the uplink grant to transmit PDU set C.

It is also possible that a gNB may indicate the index, but provides a larger grant than the corresponding PDU set size. In this case, a UE can be free to choose any other PDU sets for transmission, choose the next PDU set in the queue, or add padding bits.

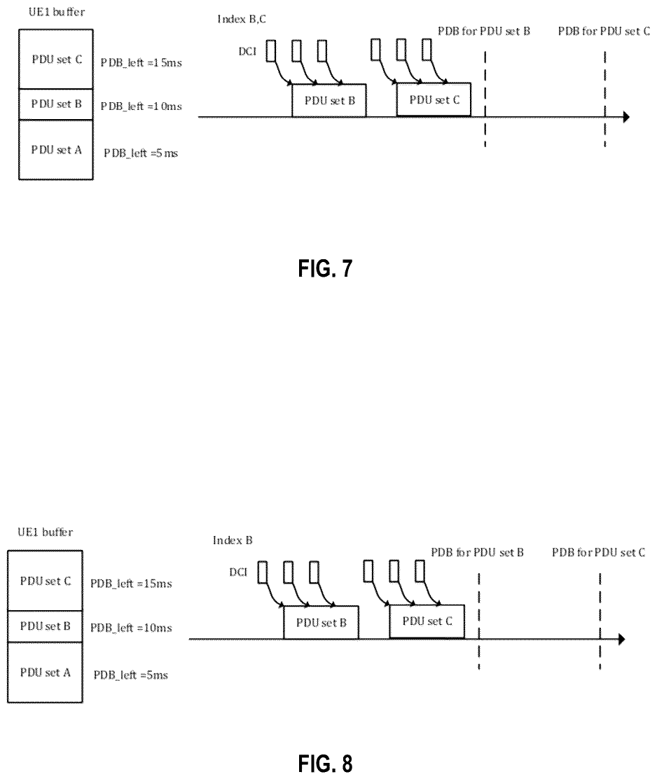

Referring to FIG. 7, in some embodiments, a gNB may send more than one index if there is enough resource for multiple PDU sets, so that a UE can send the indicated multiple PDU sets in the grants. The multiple indexes can be sent for every DCI or may be sent only when the indexes should be changed. In the example of FIG. 7, the gNB sends indications of both index B and C, and in response, the UE transmits only PDUs from PDU sets B and C using the subsequent UL grants.

Referring to FIG. 8, in some embodiments, when a gNB sends an index, the UE may only transmit PDUs from PDU sets corresponding to that index and onwards, but not from earlier indexes. In the example shown in FIG. 8, PDU set B is indicated by the gNB, and is transmitted before PDU set A. Once PDU set B is transmitted, the UE would transmit PDU set C.

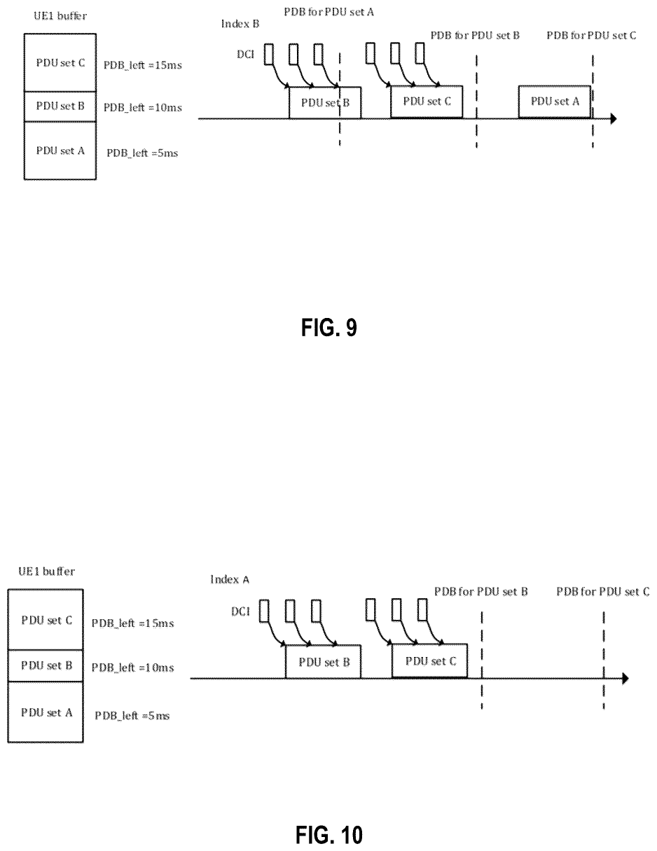

In the previous examples, other PDU sets which arrived later than a PDU set that is difficult/impossible to deliver in time (PDU set A in the example below), are indicated by the gNB and transmitted by the UE. In the example of FIG. 9, the PDU set that was bypassed (PDU set A in this example) can be transmitted when no more PDU sets are available in the queue, even if the PDB for the bypassed PDU has expired. These options could also be indicated in the DCI.

Referring to FIG. 10, in some embodiments, a gNB may send PDU set index(es) that should be excluded from transmission. The UE may select other data to fill the grant. As before this data can be of multiple options, e.g. the next available PDU set in the queue, other PDU Sets, padding bits, data for other LCGs, but no bits from the excluded PDU Set(s) are allowed to be put in the grant unless a new grant indicates that it is allowed.

In the example of FIG. 10, the gNB indicates index A. Thus, in the subsequent UL transmissions, the UE may only transmit data from other PDU sets (e.g., PDU sets B and C).

In addition to or instead of being carried in DCI, the indications described above can be also sent in a MAC CE or a MAC sub-header for a MAC PDU.

The gNB indication of PDU set can be also used to allow a UE to drop the PDU set bits which cannot be scheduled. This can be implicitly done when the grant does not indicate scheduling of certain PDU sets or can be explicitly signaled as the part of DCI indication.

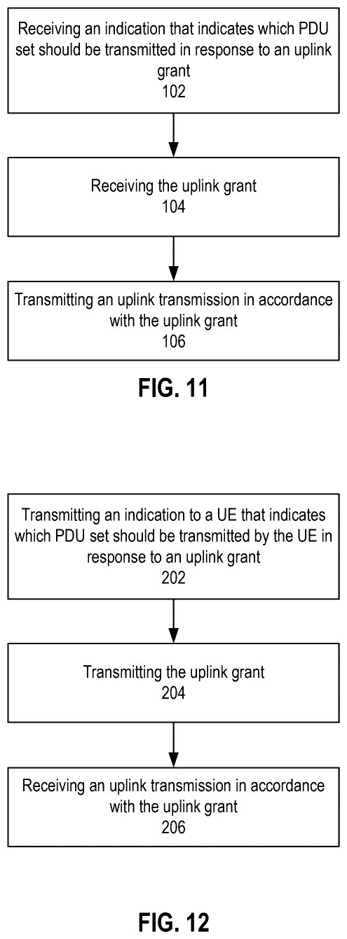

FIG. 11 illustrates a method performed by a UE according to some embodiments. The method includes receiving (block 102) an indication from a network node that indicates which PDU set, among a plurality of PDU sets in a transmit buffer of the UE, is to be transmitted by the UE in response to a uplink grant corresponding to the indication. The method further includes receiving (block 104) an uplink grant corresponding to the indication, and transmitting (block 106) an uplink transmission including a PDU from the indicated PDU set according to the uplink grant in accordance with the indication.

In some embodiments, the indication indicates a PDU set in the transmit buffer of the UE that can be transmitted according to the uplink grant.

In some embodiments, the indication indicates a plurality of PDU sets in the transmit buffer of the UE that can be transmitted according to the uplink grant.

In some embodiments, the indication comprises an index of the PDU set.

In some embodiments, the indication indicates that the UE should transmit PDU sets having an index determined relative to the indicated index. For example, the indication may indicate that the UE should transmit PDU sets having an index at least as high as the indicated index.

In some embodiments, the indication indicates a PDU set in the transmit buffer that should not be transmitted according to the uplink grant.

In some embodiments, the indication is sent in a DCI message containing the uplink grant.

In some embodiments, the method further includes transmitting a PDU set, other than the indicated PDU set, after transmitting the indicated PDU set.

In some embodiments, the indication is sent in a control message. The control message may be a MAC CE.

FIG. 12 illustrates a method performed by a network node. The method includes transmitting (block 202) an indication to a UE that indicates which PDU set, among a plurality of PDU sets in a transmit buffer of the UE, should be transmitted by the UE in response to a uplink grant corresponding to the indication. The method further includes transmitting (block 204) an uplink grant to the UE corresponding to the indication, and receiving (block 206) an uplink transmission from the UE including a PDU from the indicated PDU set according to the uplink grant in accordance with the indication.

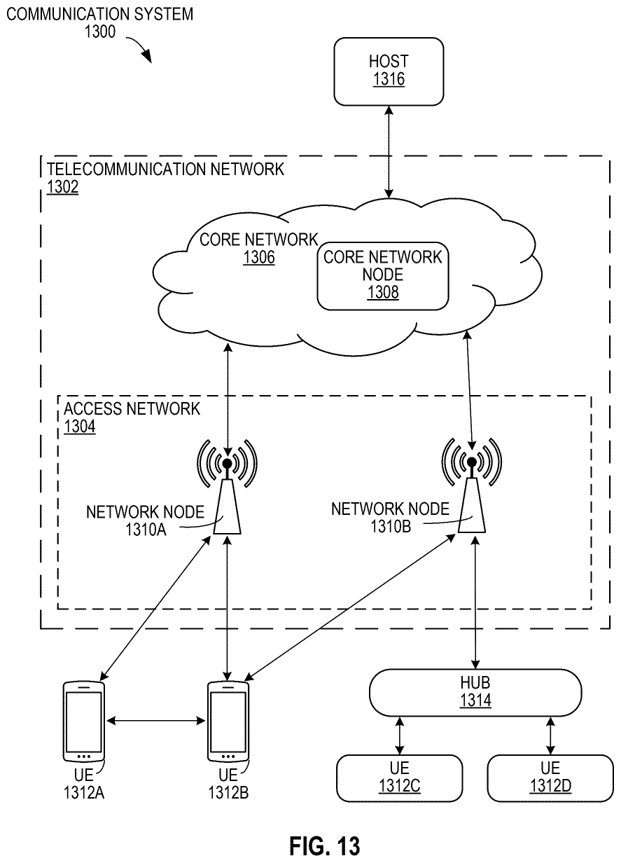

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3^{rd} Generation Partnership Project (3GPP) access node or non-3GPP access point. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub-that is, a hub whose primary function is to route communications to/from the UEs from/to the network node 1310b. In other embodiments, the hub 1314 may be a non-dedicated hub-that is, a device which is capable of operating to route communications between the UEs and network node 1310b, but which is additionally capable of operating as a communication start and/or end point for certain data channels.

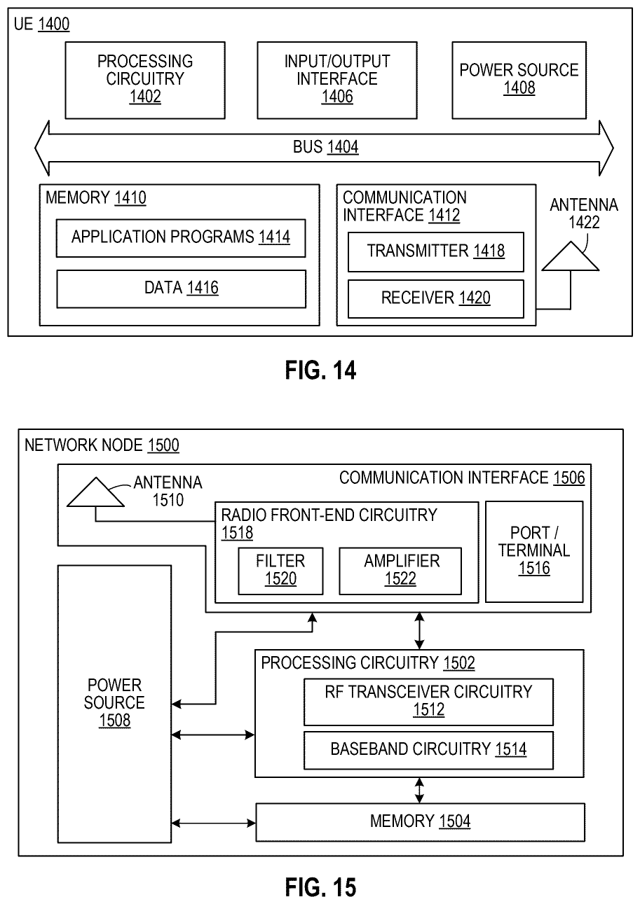

FIG. 14 shows a UE 1400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

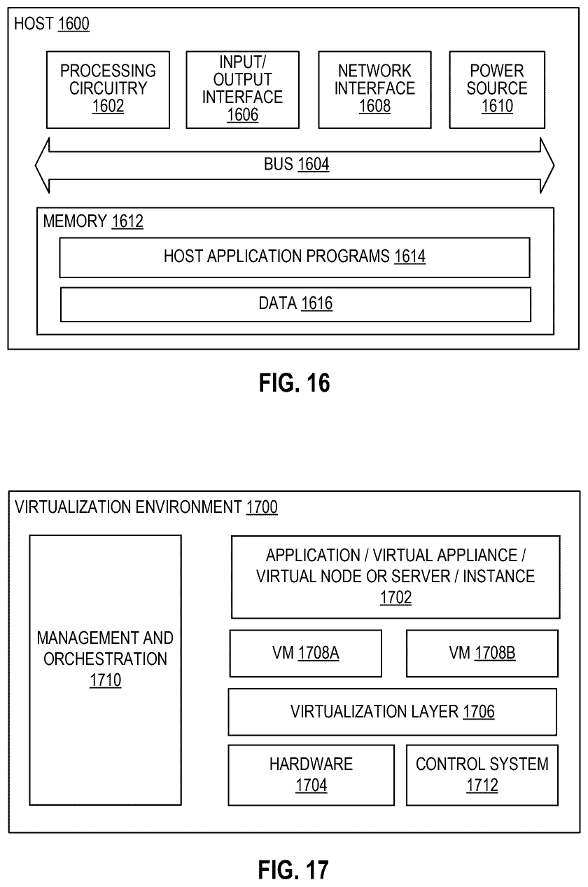

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

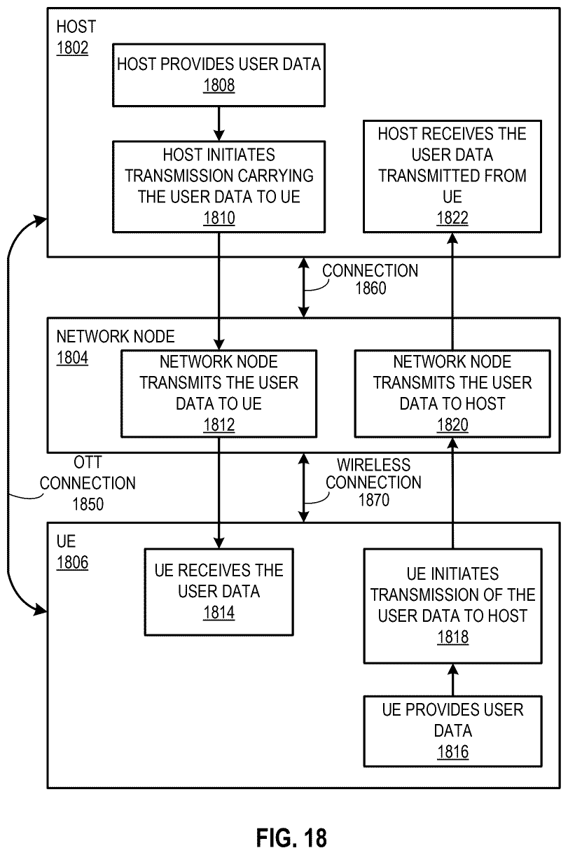

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment. More precisely, the teachings of these embodiments may improve the resource utilization and reduce overhead of a wireless channel and thereby provide benefits such as reduced user waiting time, better responsiveness and/or extended battery lifetime.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment, UE, the method comprising:
receiving an indication from a network node that indicates which protocol data unit, PDU, set, among a plurality of PDU sets in a transmit buffer of the UE, is to be transmitted, by the UE, in response to an uplink grant corresponding to the indication;
receiving the uplink grant corresponding to the indication; and
transmitting an uplink transmission according to the uplink grant in accordance with the indication.

2. The method of claim 1, wherein the indication indicates at least one PDU set in the transmit buffer of the UE that can be transmitted according to the uplink grant.

3. (canceled)

4. The method of claim 1, wherein the indication comprises an index of the PDU set.

5-6. (canceled)

7. The method of claim 1, wherein the indication indicates a PDU set in the transmit buffer that should not be transmitted according to the uplink grant.

8. The method of claim 1, wherein the indication is sent in a downlink control information, DCI, message containing the uplink grant.

9. The method of claim 1, further comprising transmitting a PDU set, other than the indicated PDU set, after transmitting the indicated PDU set.

10. The method of claim 1, wherein the indication is sent in a control message.

11-12. (canceled)

13. A user equipment, comprising:
processing circuitry configured to perform operations comprising:
receive an indication from a network node that indicates which protocol data unit, PDU, set, among a plurality of PDU sets in a transmit buffer of the UE, is to be transmitted, by the UE, in response to an uplink grant corresponding to the indication;
receive the uplink grant corresponding to the indication; and
transmit uplink transmission according to the uplink grant in accordance with the indication; and
power supply circuitry configured to supply power to the processing circuitry.

14. (canceled)

15. A method performed by a network node, comprising:
transmitting an indication to a user equipment, UE, that indicates which protocol data unit, PDU set, among a plurality of PDU sets in a transmit buffer of the UE, is to be transmitted, by the UE, in response to an uplink grant corresponding to the indication;
transmitting the uplink grant corresponding to the indication to the UE; and
receiving an uplink transmission from the UE according to the uplink grant in accordance with the indication.

16. The method of claim 15, wherein the indication indicates at least one PDU set in the transmit buffer of the UE that can be transmitted according to the uplink grant.

17. (canceled)

18. The method of claim 15, wherein the indication comprises an index of the PDU set.

19-20. (canceled)

21. The method of claim 15, wherein the indication indicates a PDU set in the transmit buffer that should not be transmitted according to the uplink grant.

22. The method of claim 15, wherein the indication is sent in a downlink control information, DCI, message containing the uplink grant.

23. The method of claim 15, further comprising receiving a PDU set, other than the indicated PDU set, from the UE after receiving the indicated PDU set.

24. The method of claim 15, wherein the indication is sent in a control message.

25-26. (canceled)

27. A network node, comprising:
processing circuitry configured to perform operations comprising:
transmitting an indication to a user equipment, UE, that indicates which protocol data unit, PDU set, among a plurality of PDU sets in a transmit buffer of the UE, is to be transmitted, by the UE, in response to an uplink grant corresponding to the indication;
transmitting the uplink grant corresponding to the indication to the UE; and
receiving an uplink transmission from the UE according to the uplink grant in accordance with the indication; and
power supply circuitry configured to supply power to the processing circuitry.

28. (canceled)
